(19) United States
(12) Patent Application Publication
(10) Pub. No.: US 2019/0226509 A1
(43) Pub. Date: Jul. 25, 2019

(54) CONNECTOR

(71) Applicant: Neil Ashton Merlo, Foxton (NZ)

(72) Inventor: Neil Ashton Merlo, Foxton (NZ)

(21) Appl. No.: 16/226,373

(22) Filed: Dec. 19, 2018

(30) Foreign Application Priority Data
Jan. 23, 2018 (NZ) NZ739344

(51) Int. Cl. F16B 5/06; F16B 2/18; F16B 12/20

(52) U.S. Cl. CPC F16B 5/0614; F16B 12/20; F16B 2/185

(57) ABSTRACT

A connector for insertion into two connectable items consists of two parts with inter-engaging features, for instance, a spigot and socket, which may be latched together under the force applied by a pivoting latch arm in one part with a tensionable clamping arm engaging the other part to clamp the two parts together when the latch arm is homed.

### TECHNICAL FIELD

The invention generally relates to two-part connectors predominantly adapted to join panels.

More particularly the invention relates to flush fitting disconnectable connectors.

### BACKGROUND ART

Articles such as panel connectors are known and provide the ability to connect two wooden or composite panels or other parts to be joined together either linearly or at right angles. Such connectors are normally of rotatable cam design with a cam on one panel interacting with an embedded pin on a second panel to secure them together when the cam is rotated. Other designs embed a threaded dowel within one panel and a connecting screw embedded in a second panel with sufficient access to screw the two together.

Such connectors may be disconnectable but disconnecting often results in damage to the joined panels as stresses are relieved by movement of parts which have become embedded in the panel itself and it becomes impossible to accurately reconnect the panels.

Therefore, a need exists for a solution to the problem of allowing easy disconnection and reconnection of panel parts.

The present invention provides a solution to this and other problems which offers advantages over the prior art or which will at least provide the public with a useful choice.

All references, including any patents or patent applications cited in this specification, are hereby incorporated by reference. No admission is made that any reference constitutes prior art.

The discussion of the references states what their authors assert, and the applicants reserve the right to challenge the accuracy and pertinence of the cited documents. It will be clearly understood that, although a number of prior art publications are referred to herein, this reference does not constitute an admission that any of these documents form part of the common general knowledge in the art, in China, or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e., that it will be taken to mean an inclusion of not only the listed components it directly references, but also other non-specified components or elements. This rationale will also be used when the term ‘comprised’ or ‘comprising’ is used in relation to one or more steps in a method or process.

### SUMMARY OF THE INVENTION

In one exemplification the invention consists in a connector system including a first connector part and a second connector part, the two parts having mutually engaging configurations which lockably engage under compression, the first connector part receiving within a cavity a pivotable latch arm, the latch arm having a pivotable clamping arm, the clamping arm having a portion receivable within the second connector part when the two connector parts are mutually engaged and the latch arm is pivoted from the receiving cavity, the clamping arm being capable of compressing the two connector parts into lockable engagement when the pivotable latch arm is pivoted into the receiving cavity and the pivot of the pivotable clamping arm passes overcentre of the pivotable latch arm, the connector parts being receivable in separated substrates.

Preferably the mutually engageable connector parts are a single groove on one part and a cooperating projection on the other part.

Preferably the mutually engageable connector parts are a spigot on one part and a co-operating socket on the other part.

Preferably the mutually engageable connector parts are multiple grooves and projections on one part and a cooperating projections and grooves on the other part.

Preferably the connector parts include projections lateral to the plane of the latch arm.

Preferably the connector parts include ridges to engage with the substrate.

Preferably the connector parts are coplanar.

In a further embodiment the invention consists in a method of connecting two substrates wherein:
a first connector part is embedded in a first substrate and a second connector part is embedded in a second substrate, the two connector parts having mutually engaging configurations which lockably engage under compression, the first connector part having within a cavity a pivotable latch arm, the latch arm having a pivotable clamping arm, the clamping arm having a portion receivable within the second connector part when the two connector parts are mutually engaged and the latch arm is pivoted from the receiving cavity, the clamping arm being capable of compressing the two connector parts into lockable engagement when the pivotable latch arm is pivoted into the receiving cavity and the pivot of the pivotable clamping arm passes overcentre of the pivotable latch arm, the two substrates being thereby connected.

Preferably the substrates are substantially at right angles.

Preferably the substrates are substantially coplanar.

Preferably, the connectors are configured as a part circle shape, or a part pyramid shape, or a part square shape and to connect substrates to be coplanar through to a 90° angle.

These and other features of as well as advantages which characterise the present invention will be apparent upon reading of the following detailed description and review of the associated drawings.

### BRIEF DESCRIPTION OF THE DRAWINGS

FIG. 1 is a general perspective view of an assembled connector.

FIG. 2 shows one such example in exploded view where male portion

FIG. 3 shows a top view of the male and female parts

FIG. 4 shows in partial cross-section the spigot engaging joiner

### DESCRIPTION OF THE INVENTION

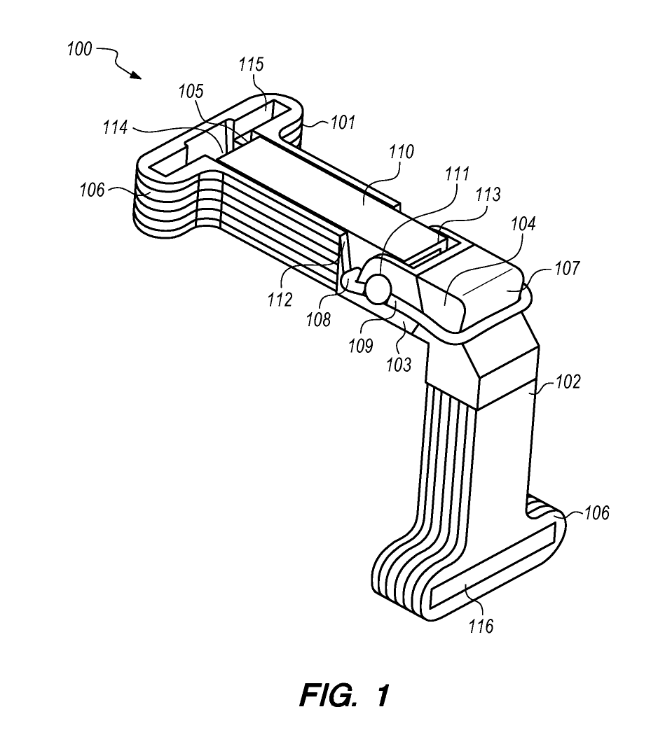

Referring now to FIG. 1 a joining or connector system 100 is shown. The system includes a first male connector part 101 and a second female connector part 102.

Female part 102 includes a re-entrant shaping in head 104 which can receive an entrant head shaping 103 of male part 101. The apex of the shaping may be central of the height of the connector parts or may be offset slightly. Female part 102 has a retaining groove 107 to accept a clamping arm 109. While the major part of the female connector part 102 is shown at right angles to male connector part 101 it may equally be aligned with the male part 101 in which case the groove 107 may only be wide enough to accept arm 109.

Male part 101 has a cavity 114 in which a latch arm 110 may be located. The latch arm 110 pivots about a pin 111 located slightly upwards of the vertical centreline of the male part 101. Pivotally attached to the latch arm 110 is a clamping arm 109 which is engageable in groove 107 when the latch arm 110 is pivoted upwards about pin 111. The clamping arm locates within a recess 112 in both sides of the male member 101 when the latch arm 110 is locked.

The latch arm 110 is held in place by a pivot pin 111 though male member 101 and may be lifted by engaging the end within cavity 114 remote from pivot pin 111. Once lifted the two normally separated parts 101 and 102 may be mated, clamping arm 109 may be moved to within groove 107 and the latch arm may be pivoted back within the cavity 114. In doing this clamping arm 109 is tensioned and extends slightly by straightening a bow in the clamping arm sides. With the clamping arm under tension the latching arm enters groove 112 and passes overcentre of pivot pin 111, thus locking the latch arm 110 within the cavity 114.

The latch arm may be pivoted upwards again by engaging the remote end of the latch arm 110 within cavity 114 and forcing it upwards, thereby lifting the clamping arm 109 upwards overcentre to release the tension holding the two parts 101, 102 together.

In use parts 101 and 102 are fitted to cavities in the substrate of separate panels or similar articles, usually with multiple connectors. Both parts 101 and 102 may have external ribs to engage the panels into which they are fitted. The panels can then be maneuvered so that parts 101 and 102 engage and once the clamping arms are in place the latch arms may be closed to affix the two panels in the required relationship.

Preferably the parts 101, 102 may have transverse extensions 106 to spread the load imposed on the panels to which they are fitted. Preferably parts 101, 102 also have cavities 115,116 in the transverse extensions to reduce the amount of material required and to provide a location for the attachment of a cover plate for the connectors if required.

The interacting male and female parts 103, 104 are shown as a single groove and cooperating engaging part but may consist of multiple grooves and cooperating engaging parts or of any other configuration of parts which may engage by being laterally or longitudinally slideable.

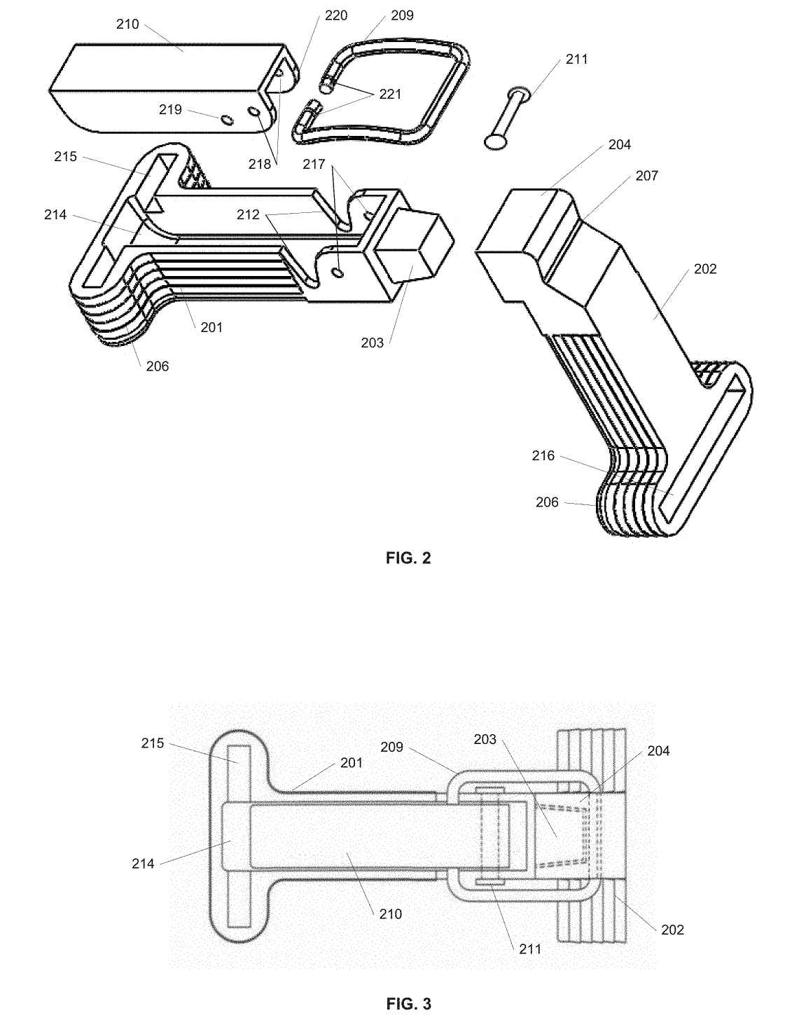

FIG. 2 shows one such example in exploded view where male portion 201 has a rectangular spigot 203 fitting within the head 204 of female part 202. Also shown is the latch pivot pin 211, locating in holes 217 in the male body 201 and in holes 218 in the latch arm 210. The latch arm 210 has curved edges 220 allowing lifting of the latch arm when pivoting around pin 211. The clamping arm 209, which locates in holes 219 of the latch arm, engages in groove 207 of the female head 204. Preferably the clamping arm ends 221 are angled and contoured to remain within holes 219 and the clamping arm 209, once homed within slot 214 has inadequate clearance to allow the ends 221 to escape from the latch arm 210. Cut-out 214, into which the latch arm 210 is fitted, has sufficient room behind the latch arm 210 to allow lifting of it. Cut-outs 215 and 216 allow the fitting of covering plates if required.

FIG. 3 shows a top view of the male and female parts in FIG. 2 and shows spigot 202 engaged within a cavity within head 204 and clamping arm 209 engaged in groove 207 of head 204. Latch arm 210 is within cut out 214 and pivot pin 211 is engaged with the latch arm 210 and the male part body 201.

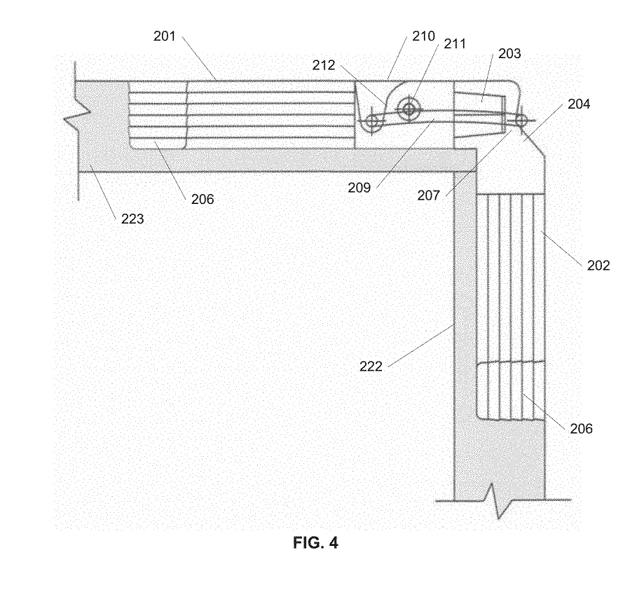

FIG. 4 shows in partial cross-section the spigot engaging joiner of FIG. 2 in use to join together two panels 2222 and 223. The two parts of the joiner or connector are located within cut-outs in the panels with spigot 203 engaging in head 204. Latch arm 210, which was originally pivoted upwards to drop clamping arm 209 into groove 207 in the head 204 of the female part, has been returned to the clamping position within the male body 201. In doing so the bow in clamping arm 209 had reduced as the tension on the arm has increased and in entering groove 212 the clamping arm has gone beyond the pivot 211 of the latch arm. This over centre action prevents the latch from releasing, regardless of the pressure applied to separate the two parts of the joiner.

Panel parts 222 and 223 are therefore securely clamped together.

While clamping arm 209 is shown bowed it may be of some other configuration which allows some tensioning possibilities while still providing the clamping force required, for instance joggled or of a material of limited extensibility.

While the projecting portion of the cooperating parts is shown as being on the part with the latch arm the projecting portion may equally be on the part without the latch arm.

A preferred, but non-limiting, aspect of the invention is directed to a connector having:
(i) a Female T shaped body with a tapered mortise opening.
(ii) a Male T-shaped body containing a tapered tenon that marries into the tapered mortise of the female T-shaped body,
(iii) a pivoting latch hingable to a pin, the latch holding a clamping arm, characterised in that when the clamp is in a locked position both bodies are securely fastened together wherein both T-shaped bodies are firmly bound at a desired angle.

Preferably, both jointer outer bodies are ribbed too maintain a secure hold when inserted in the panel. Ribs have an interference fit of 0.5 mm per side.

Machine Housing the Jointer

Both male and female parts are precisely machine housed 12 mm depth in their respective cabinet components.

Preferably, the male and female components are CNC machined or can be routed using a template.

Cabinet component panels are, end panels, top panels, base panels, back panels.

When the connector housing machining process is completed the T-shaped male and T-shaped female connector components are inserted into the housing. They are then press fitted or knocked to fit each of the respective matching cabinet components.

Method of Assembly

The cabinet/panel/wall components can be assembled together on the face edges or on the back edges of the cabinet/panel/wall components.

Step 1: Bring the end panel and base bodies together aligning the connector tapered mortises and tenons to marry both bodies together.

Step 2: When both bodies are married together, swing the pivoting latch containing the clamping arm away from the male body.

Step 3: Secure the clamping arm under the female body.

Step 4: Push the pivoting latch back into the male body securely fastening both male and female components firmly together.

To unlock the connector, swing the pivoting latch away from the male body and swing the clamping arm away from the female body and pull the two components apart.

Reverse the process to re-assemble.

It is to be understood that even though numerous characteristics and advantages of the various embodiments of the present invention have been set forth in the foregoing description, together with details of the structure and functioning of various embodiments of the invention, this disclosure is illustrative only, and changes may be made in detail so long as the functioning of the invention is not adversely affected.

For example, the particular elements of the connector may vary dependent on the particular application for which it is used without variation in the spirit and scope of the present invention.

Also included within the scope of the invention are connectors configured as a part circle shape, or a part pyramid shape, or a part square shape and to connect substrates be coplanar through to a 90° angle.

In addition, although the preferred embodiments described herein are directed to connectors for use in a panel connecting system, it will be appreciated by those skilled in the art that variations and modifications are possible within the scope of the appended claims.

### INDUSTRIAL APPLICABILITY

The connectors of the invention is used in the assembly of various devices which are employed it the furniture, cabinet or construction industry. The present invention is therefore industrially applicable.

The connectors may be used for, but not limited to the following:

Cabinet making

Manufacture/installation of internal housing panels

Manufacture/installation of external housing panels

Office partitions

Desks

Theatrical partitions

In the building of schools, offices, pre-fabs, pop-up buildings, emergency shelters, portable forensic stations, emergency medical facilities, etc.

The term ‘connector’ has been used in this specification and may be used inter-changeably with the term ‘jointer’ or similar.

1. A connector system including comprising:
a first connector part; and
a second connector part, the two parts having mutually engaging configurations which lockably engage under compression, the first connector part receiving within a receiving cavity a pivotable latch arm, the latch arm having a pivotable clamping arm, the clamping arm having a portion receivable within the second connector part when the two connector parts are mutually engaged and the latch arm is pivoted from the receiving cavity, the clamping arm being capable of compressing the two connector parts into lockable engagement when the pivotable latch arm is pivoted into the receiving cavity and the pivot of the pivotable clamping arm passes overcentre of the pivotable latch arm, the first connector part and the second connector part being receivable in a first substrate and a second substrate, respectively.

2. The connector system as claimed in claim 1 wherein the mutually engageable connector parts include a single groove on one part and a cooperating projection on the other part.

3. The connector system as claimed in claim 1 wherein the mutually engageable connector parts include a spigot on one part and a cooperating socket on the other part.

4. The connector system as claimed in claim 1 wherein the mutually engageable connector parts include multiple grooves and projections on one part and co-operating projections and grooves on the other part.

5. The connector system as claimed in claim 1 wherein the connector parts include projections lateral to a plane of the latch arm.

6. The connector system as claimed in claim 1 wherein the connector parts each include ridges to engage with the corresponding substrate.

7. The connector system as claimed in claim 1 wherein the connector parts are configured to connect the first substrate and the second substrate to be coplanar through to a 90° angle relative to one another.

8. The connector system as claimed in claim 1 wherein the connector parts are configured to connect the first substrate and the second substrate to be coplanar through to a 45° angle relative to one another.

9. The connector system as claimed in claim 1 wherein the connector parts are configured to connect the first substrate and the second substrate to be coplanar with one another.

10. A method of connecting a first substrate and a second substrate, the method comprising the steps of:
embedding a first connector part in the first substrate;
embedding a second connector part in the second substrate; and
connecting the first substrate to the second substrate, the two connector parts having mutually engaging configurations which lockably engage under compression, the first connector part having within a cavity a pivotable latch arm, the latch arm having a pivotable clamping arm, the clamping arm having a portion receivable within the second connector part when the two connector parts are mutually engaged and the latch arm is pivoted from the receiving cavity, the clamping arm being capable of compressing the two connector parts into lockable engagement when the pivotable latch arm is pivoted into the receiving cavity and the pivot of the pivotable clamping arm passes overcentre of the pivotable latch arm.

11. The method as claimed in claim 10 wherein the step of connecting includes the substrates being substantially at right angles relative to one another.

12. The method as claimed in claim 10 wherein the step of connecting includes the substrates being substantially coplanar with one another.

13. The method as claimed in claim 10 wherein the step of connecting includes the mutually engageable connector parts including a single groove on one part and a cooperating projection on the other part.

14. The method as claimed in claim 10 wherein the step of connecting includes the mutually engageable connector parts including a spigot on one part and a cooperating socket on the other part.

15. The method as claimed in claim 10 wherein the step of connecting includes the mutually engageable connector parts including multiple grooves and projections on one part and co-operating projections and grooves on the other part.

16. The method as claimed in claim 10 wherein the step of connecting includes the connector parts including projections lateral to a plane of the latch arm.

17. The method as claimed in claim 10 wherein the connector parts each include ridges to engage with the corresponding substrate.

18. A connector system for selectively connecting a first substrate and a second substrate, the connector system comprising:
a first connector part that is configured to be selectively coupled to the first substrate, the first connector part including a head, a latch arm that is pivotably coupled to the head, and a clamping arm that is pivotably coupled to the latch arm; and
a second connector part that is configured to be selectively coupled to the second substrate, the second connector part including a head that is sized and shaped to selectively engage the head of the first connector part, and a receiving groove that is configured to selectively receive the clamping arm of the first connector part;
wherein the clamping arm is pivotable relative to the latch arm between an engaged configuration, where the clamping arm is positioned to engage the receiving groove of the second connector part, and a disengaged configuration, where the clamping arm does not engage the receiving groove of the second connector part.

19. The connector system of claim 18 wherein the first connector part further defines a receiving cavity; and wherein the latch arm pivots relative to the head of the first connector part so that latch arm can be alternatively positioned within the receiving cavity and pivoted from the receiving cavity.

20. The connector system of claim 19 wherein when the latch arm is positioned within the receiving cavity and the clamping arm is in the engaged configuration, the first connector part lockably engages the second connector part, and the first substrate can be lockably connected to the second substrate.
